(19) United States
(12) Patent Application Publication
(10) Pub. No.: US 2018/0005444 A1
(43) Pub. Date: Jan. 4, 2018

(54) AUGMENTED REALITY FAILSAFE MODE

(71) Applicant: DAQRI, LLC, Los Angeles, CA (US)

(72) Inventor: Brian Mullins, Altadena, CA (US)

(21) Appl. No.: 15/199,794

(22) Filed: Jun. 30, 2016

(51) Int. Cl. G06T 19/00; G06T 15/00; G06F 3/01

(52) U.S. Cl. CPC G06T 19/006; G06T 19/003; G06F 3/012; G06T 15/005

(57) ABSTRACT

A device executes an augmented reality (AR) application at the device. The device detects a failure of the AR application and enters a failsafe mode in response to detecting the failure of the AR application. The failsafe mode includes a minimum set of AR content and AR application functionalities relative to the full set of AR content and AR application functionalities when the AR application is being executed.

### TECHNICAL FIELD

The subject matter disclosed herein generally relates to an augmented reality device. Specifically, the present disclosure addresses systems and methods for providing a failsafe mode in an augmented reality environment.

### BACKGROUND

When an application fails on a computer system, the computer system may revert to a mode also known as “safe mode” where basic functionalities are provided to the user to debug and diagnose the application. For example, in Windows®, a text-based debug console or command shell is typically provided after the application crashes. The display of a text-based debug console is acceptable for a desktop computer environment. However, displaying a text-based debug console in a display of an augmented reality (AR) device creates a disparity between the three-dimensional working environment of the AR device and the two-dimensional text-based debug console.

### BRIEF DESCRIPTION OF THE DRAWINGS

Some embodiments are illustrated by way of example and not limitation in the figures of the accompanying drawings.

FIG. 1 is a block diagram illustrating an example of a network suitable for an augmented reality (AR) device, according to some example embodiments.

FIG. 2 is a block diagram illustrating an example embodiment of an AR device.

FIG. 3 is a block diagram illustrating examples of sensors.

FIG. 4 is a block diagram illustrating an example embodiment of a transition from a normal AR mode to a failsafe AR mode.

FIG. 5 is a block diagram illustrating an example embodiment of a transition from a normal AR mode to a failsafe AR mode.

FIG. 6 is a flowchart illustrating a method for operating a failsafe mode of an AR device, according to an example embodiment.

FIG. 7 is a flowchart illustrating a method for operating a failsafe mode of an AR device, according to an example embodiment.

FIG. 8 is a block diagram illustrating components of a machine, according to some example embodiments, able to read instructions from a machine-readable medium and perform any one or more of the methodologies discussed herein.

### DETAILED DESCRIPTION

Example methods and systems are directed to a failsafe mode of an augmented reality (AR) device. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

When an application executing in a computer fails or crashes, the operating system of the computer activates a failure diagnosis also referred to as a safe mode to engage and enable only few necessary applications and processes. The safe mode typically displays information in a text-based debug console. The display of the text-based debug console or a “blue screen” (as typically shown in desktop computing device) in a display of an AR device causes a strong disparity for the user viewing three-dimensional objects to seeing a blue screen or a two-dimensional text-based debug console.

The present application describes a failsafe mode for AR devices where core-level functionalities and debug tools of the AR system are layered in its root operation. Core-level functionalities including basic functions are essential to executing the AR application. The AR device is able to call necessary hardware and software to still support basic AR environment and operations in a safe mode situation. Therefore, core tools, access, and information channels are maintained as part of the AR experience provided by the AR device. The AR device provides low-level AR capabilities that are still available during a system failure.

In one example embodiment, a device operates an AR application at the device. The device detects a failure of the AR application and provides a failsafe mode in response to detecting the failure of the AR application. The failsafe mode includes a limited set of AR content and AR application functionalities relative to the full set of AR content and AR application functionalities when the AR application is operating. The limited set of AR content includes a core, basic, or minimum set of AR content.

In another example embodiment, each AR device includes an AR application that identifies a real-world object depicted in an image captured with a camera of a respective AR device, retrieves a three-dimensional (3D) virtual object from the AR content based on the identified object, and renders the three-dimensional model of the virtual object in a display of a corresponding AR device. The virtual object is perceived as an overlay on the real-world object.

The display of the AR device may be retracted inside a head mounted device (e.g., helmet) and extended outside the helmet to allow a user to view the display. The position of the display surface may be adjusted based on an eye level of the user. The display surface includes a display that displays the AR content. The helmet may include a computing device such as a hardware processor with an AR application that allows the user wearing the helmet to experience information, such as in the form of a virtual object such as a 3D virtual object, overlaid on an image, or a view of a physical object (e.g., a gauge) captured with a camera in the helmet. The helmet may include optical sensors. The physical object may include a visual reference (e.g., a recognized image, pattern, or object, or unknown objects) that the AR application can identify using predefined objects or machine vision. A visualization of the additional information (also referred to as AR content), such as the 3D virtual object overlaid or engaged with a view or an image of the physical object, is generated in the display lens of the helmet. The display lens may be transparent to allow the user see through the display lens. The display lens may be part of a visor or face shield of the helmet or may operate independently from the visor of the helmet. The 3D virtual object may be selected based on the recognized visual reference or captured image of the physical object. A rendering of the visualization of the 3D virtual object may be based on a position of the display relative to the visual reference. Other AR applications allow the user to experience visualization of the additional information overlaid on top of a view or an image of any object in the real physical world.

The virtual object may include a 3D virtual object, a two-dimensional (2D) virtual object, or both. For example, the 3D virtual object may be or include a 3D model of an engine part (e.g., animated in 3D). The 2D virtual object may be or include a 2D window showing a dialog box, menu, or written information such as statistics information for properties or physical characteristics of the corresponding physical object (e.g., temperature, mass, velocity, tension, stress). The AR content (e.g., image of the virtual object, virtual menu) may be rendered at the helmet or at a server in communication with the helmet. In one example embodiment, the user of the helmet may navigate the AR content using audio and visual inputs captured at the helmet or other inputs from other devices, such as a wearable device. For example, the display lenses may extract or retract based on a voice command of the user, a gesture of the user, or a position of a watch in communication with the helmet.

In another example embodiment, a non-transitory machine-readable storage device may store a set of instructions that, when executed by at least one processor, causes the at least one processor to perform the method operations discussed within the present disclosure.

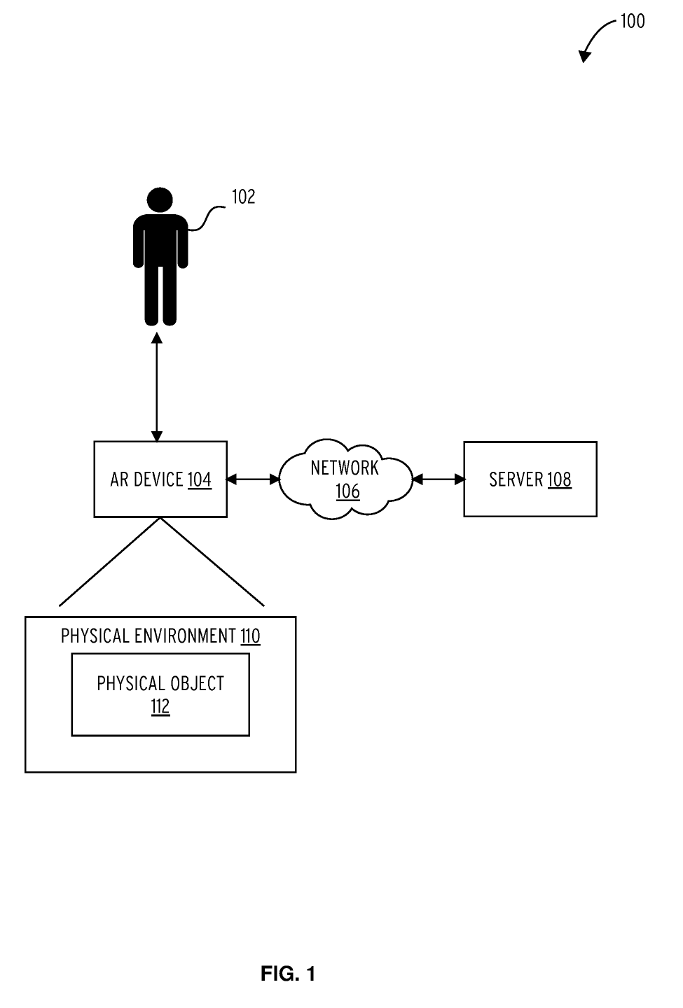

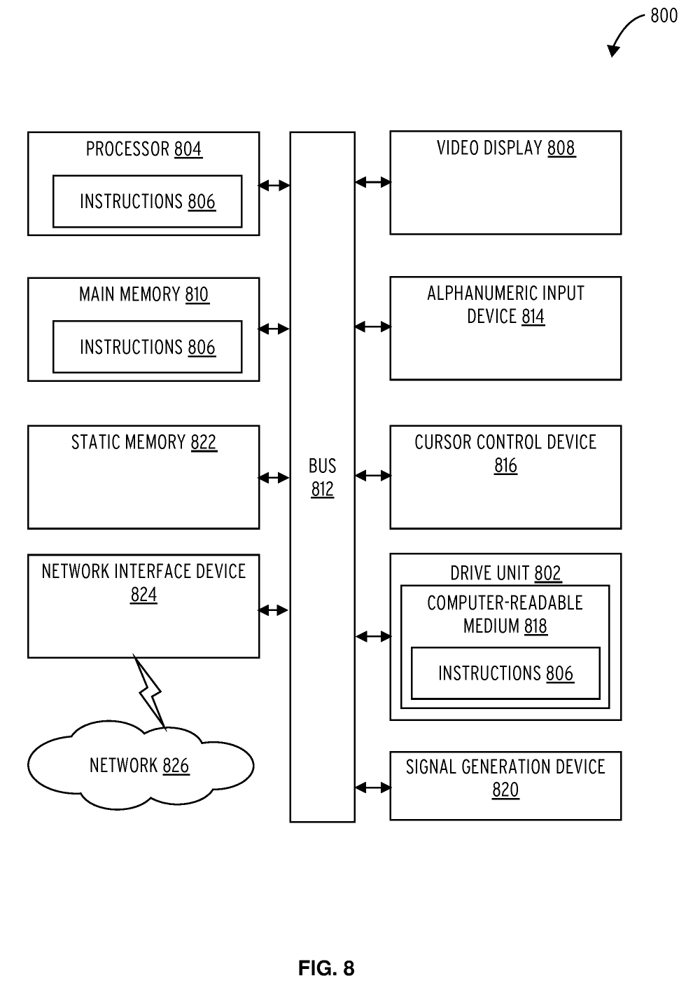

FIG. 1 is a network diagram illustrating a network environment 100 suitable for operating an AR application of an AR device, according to some example embodiments. The network environment 100 includes an AR device 104 and a server 108, communicatively coupled to each other via a network 106. The AR device 104 and the server 108 may each be implemented in a computer system, in whole or in part, as described below with respect to FIG. 8.

The server 108 may be part of a network-based system. For example, the network-based system may be or include a cloud-based server system that provides AR content (e.g., audio or visual instructions on how to operate a tool, information about an imminent or potential threat, instructions on how to remedy the threat or minimize exposure to the threat, visualization of the threat, augmented information including 3D models of virtual objects related to physical objects in images captured by the AR device 104) to the AR device 104.

The AR device 104 includes a head-mounted device that a user 102 may wear to view the AR content related to images of a physical object 112 in a real world physical environment 110. In one example embodiment, the AR device 104 includes a computing device with a camera and a display (e.g., smart glasses, smart helmet, smart visor, smart face shield). The AR device 104 may be removably mounted to the head of the user 102. In one example, the display may be a screen that displays what is captured with a camera of the AR device 104. In another example, the display of the AR device 104 includes a transparent display or see-through display, such as in the visor or face shield of a helmet, or a display lens distinct from the visor or face shield of the helmet.

The user 102 is a user of an AR application in the AR device 104 and at the server 108. The user 102 may be a human user (e.g., a human being), a machine user (e.g., a computer configured by a software program to interact with the AR device 104), or any suitable combination thereof (e.g., a human assisted by a machine or a machine supervised by a human). The user 102 is not part of the network environment 100, but is associated with the AR device 104.

In another example embodiment, the server 108 collects sensor data from the AR device 104 and determines whether the AR device 104 is operating under a failsafe mode.

In another example embodiment, the AR application generates an AR experience triggered by identified objects in the physical environment 110. The physical environment 110 may include identifiable objects such as a 2D physical object (e.g., a picture), a 3D physical object (e.g., a factory machine), a location (e.g., at the bottom floor of a factory), or any references (e.g., perceived corners of walls or furniture) in the real world physical environment 110. The AR application includes computer vision recognition to determine corners, objects, lines, and letters.

In one example embodiment, the AR device tracks an image of the physical object 112 using a local context recognition dataset or any other previously stored dataset of the AR application of the AR device 104. The local context recognition dataset module may include a library of virtual objects associated with real-world physical objects 112. In one example, the AR device 104 identifies feature points in an image of the physical object 112 to determine different planes (e.g., edges, corners, surfaces, dials, letters). The AR device 104 may also identify tracking data related to the physical object 112 (e.g., GPS location of the AR device 104, orientation, distances to the physical object 112). If the captured image is not recognized locally at the AR device 104, the AR device 104 downloads additional information (e.g., 3D model or other augmented data) corresponding to the captured image, from a database of the server 108 over the network 106.

Any of the machines, databases, or devices shown in FIG. 1 may be implemented in a general-purpose computer modified (e.g., configured or programmed) software to be a special-purpose computer to perform one or more of the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 106 may be any network that enables communication between or among machines (e.g., server 108), databases, and devices (e.g., AR device 104). Accordingly, the network 106 may be a wired network, a wireless network (e.g., a mobile or cellular network), or any suitable combination thereof. The network 106 may include one or more portions that constitute a private network, a public network (e.g., the Internet), or any suitable combination thereof.

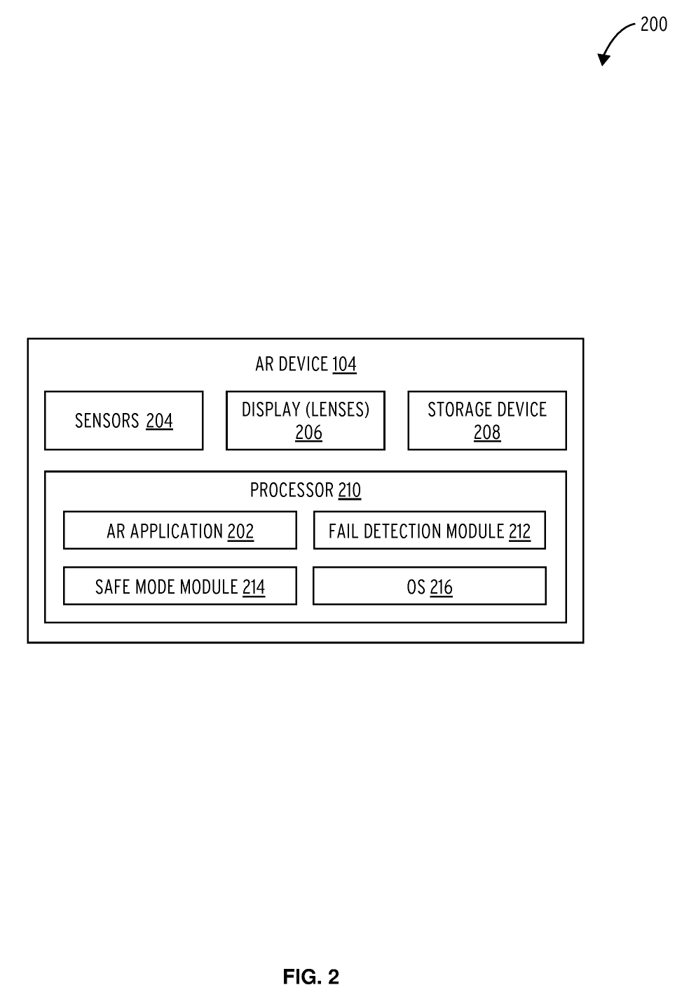

FIG. 2 is a block diagram illustrating modules (e.g., components) of the AR device 104, according to some example embodiments. The AR device 104 may be a head mounted device that includes sensors 204, a display 206, a storage device 208, and a processor 210. The AR device 104 may include other types of wearable devices.

The sensors 204 measure and generate internal tracking data of the AR device 104 to determine a geographic location, a position, and an orientation of the AR device 104. The geographic location may be determined by using, for example, a GPS device. The position and the orientation of the AR device 104 may be used to determine a field of view of the user 102. For example, the direction in which the user 102 is looking may be determined based on the position and orientation of the AR device 104 worn by the user 102. Therefore, the sensors 204 may be used to determine whether the AR device 104 is oriented towards a real world object (e.g., when the user 102 looks at physical object 112) or in a particular direction (e.g., when the user 102 tilts his head to watch his wrist). Furthermore, sensors 204 may be used to identify real world objects in a field of view of the AR device 104. For example, a virtual object may be rendered and displayed in the display 206 when the sensors 204 indicate that the AR device 104 is oriented towards the physical object 112. The virtual object may be based on a combination of sensor data from the sensors 204.

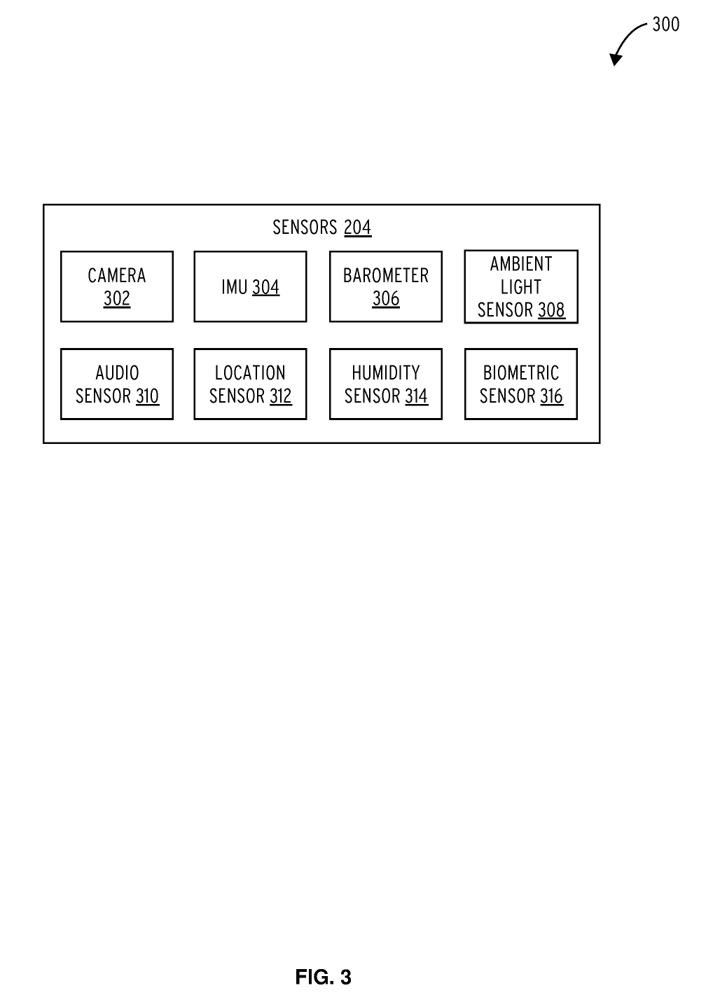

FIG. 3 is a block diagram illustrating examples of sensors. For example, the sensors 204 include a camera 302, an audio sensor 310, an IMU (e.g., inertial measurement unit) sensor 304, a location sensor 312, a barometer 306, a humidity sensor 314, an ambient light sensor 308, and a biometric sensor 316. It is noted that the sensors 204 described herein are for illustration purposes. Sensors 204 are thus not limited to the ones described.

The camera 302 includes an optical sensor(s) (e.g., camera) that may encompass different spectra. The camera 302 may include one or more external cameras aimed outside the AR device 104. For example, the external camera may include an infrared camera or a full spectrum camera. The external camera may include a rear facing camera and a front facing camera disposed in the AR device 104. The front facing camera may be used to capture a front field of view of the AR device 104 while the rear facing camera may be used to capture a rear field of view of the AR device 104. The pictures captured with the front and rear facing cameras may be combined to recreate a 360 degree view of the physical world around the AR device 104.

The camera 302 may include one or more internal cameras aimed at the user 102. The internal camera may include an infrared (IR) camera configured to capture an image of a retina of the user 102. The IR camera may be used to perform a retinal scan to map unique patterns of the retina of the user 102. Blood vessels within the retina absorb light more readily than the surrounding tissue in the retina and therefore can be identified with IR lighting. The IR camera may cast a beam of IR light into the user's eye as the user 102 looks through the display 206 (e.g., lenses) towards virtual objects rendered in the display 206. The beam of IR light traces a path on the retina of the user 102. Because retinal blood vessels absorb more of the IR light than the rest of the eye, the amount of reflection varies during the retinal scan. The pattern of variations may be used as biometric data unique to the user 102.

In another example embodiment, the internal camera may include an ocular camera configured to capture an image of an iris in the eye of the user 102. In response to the amount of light entering the eye, muscles attached to the iris expand or contract the aperture at the center of the iris, known as the pupil. The expansion and contraction of the pupil depends on the amount of ambient light. The ocular camera may use iris recognition as a method for biometric identification. The complex pattern on the iris of the eye of the user 102 is unique and can be used to identify the user 102. The ocular camera may cast infrared light to acquire images of detailed structures of the iris of the eye of the user 102. Biometric algorithms may be applied to the image of the detailed structures of the iris to identify the user 102.

In another example embodiment, the ocular camera includes an IR pupil dimension sensor that is pointed at an eye of the user 102 to measure the size of the pupil of the user 102. The IR pupil dimension sensor may sample the size of the pupil (e.g., using an IR camera) on a periodic basis or based on predefined triggered events (e.g., user 102 walks into a different room, sudden changes in the ambient light, or the like).

The audio sensor 310 includes a microphone. For example, the microphone may be used to record a voice command from the user 102. In other examples, the microphone may be used to measure ambient noise level to measure the intensity of the background noise. In another example, the microphone may be used to capture ambient noise. Analytics may be applied to the captured ambient noise to identify specific types of noises such as explosions or gunshot noises.

The IMU 304 includes a gyroscope and an inertial motion sensor to determine an orientation and movement of the AR device 104. For example, the IMU 304 measures the velocity, orientation, and gravitational forces on the AR device 104. The IMU 304 also detects a rate of acceleration using an accelerometer and changes in angular rotation using a gyroscope.

The location sensor 312 determines a geolocation of the AR device 104 using a variety of techniques such as near field communication, GPS, Bluetooth, or Wi-Fi. For example, the location sensor 312 generates geographic coordinates of the AR device 104.

The barometric sensor 306 measures atmospheric pressure differential to determine an altitude of the AR device 104. For example, the barometric sensor 306 may be used to determine whether the AR device 104 is located on a first floor or a second floor of a building.

The humidity sensor 314 determines a relative humidity level ambient to the AR device 104. For example, the humidity sensor 314 determines the humidity level of a room in which the AR device 104 is located.

The ambient light sensor 308 determines an ambient light intensity around the AR device 104. For example, the ambient light sensor 308 measures the ambient light in a room in which the AR device 104 is located.

The biometric sensor 316 includes sensors configured to measure biometric data unique to the user 102 of the AR device 104. In one example embodiment, the biometric sensors 316 include an ocular camera, an EEG (electroencephalogram) sensor, and an ECG (electrocardiogram) sensor. It is noted that the biometric sensor 316 described herein is for illustration purposes. Biometric sensors 316 are thus not limited to the ones described.

The EEG sensor includes, for example, electrodes that, when in contact with the skin of the head of the user 102, measure electrical activity of the brain of the user 102. The EEG sensor may also measure the electrical activity and wave patterns through different bands of frequency (e.g., Delta, Theta, Alpha, Beta, Gamma, Mu). EEG signals may be used to authenticate a user 102 based on fluctuation patterns unique to the user 102.

The ECG sensor includes, for example, electrodes that measure a heart rate of the user 102. In particular, the ECG may monitor and measure the cardiac rhythm of the user 102. A biometric algorithm is applied to the user 102 to identify and authenticate the user 102. In one example embodiment, the EEG sensor and ECG sensor may be combined into a same set of electrodes to measure both brain electrical activity and heart rate. The set of electrodes may be disposed around the helmet so that the set of electrodes comes into contact with the skin of the user 102 when the user 102 wears the AR device 104.

Referring back to FIG. 2, the display 206 may include a display (e.g., display surface, lens) capable of displaying AR content (e.g., images, video) generated by the processor 210. The display 206 may be transparent so that the user 102 can see through the display 206 (e.g., such as in a head-up display).

The storage device 208 stores a library of AR content. The AR content may be associated with a specific user task. For example, a user task may be assembling a component. The AR content associated with the task may display virtual objects to show how to assemble the component step by step. The AR content may be associated with the user 102 (e.g., a technician level 2 may have access to AR content related to the technician's duties and responsibilities). The AR content may be downloaded from the server 108 based on an authentication of the user 102 with the AR device 104. The AR content may include two or three dimensional models of virtual objects with corresponding audio. In other examples, the AR content may include an AR application that includes interactive features such as displaying additional data (e.g., location of sprinklers) in response to the user input (e.g., user 102 says “show me the locations of the sprinklers” while looking at an AR overlay showing location of the exit doors). AR applications may have their own different functionalities and operations. Therefore, each AR application may operate distinctly from other AR applications.

The processor 210 includes an AR application 202, a fail detection module 212, a safe mode module 214, and an operating system (OS) 216. The AR application 202 operates on a layer on top of the safe mode module 214 and the OS 216. In another example embodiment, the safe mode module 214 is part of the AR application 202 or the OS 216.

The AR application 202 generates a display of information related to the physical object 112. For example, the AR application 202 generates a visualization of information related to the physical object 112 when the AR device 104 captures an image of the physical object 112 and recognizes the physical object 112 or when the AR device 104 is in proximity to the physical object 112. For example, the AR application 202 generates a display of a holographic or virtual menu visually perceived as a layer on the physical object 112.

For example, the AR application 202 displays instructions or virtual objects demonstrating how to operate the physical object 112. The virtual objects may include three-dimensional objects that appear as a layer on top of the physical object 112. In one example embodiment, the three-dimensional objects may be scaled and positioned on corresponding parts of the physical object 112 so that the three-dimensional objects appear to be part of the physical object 112.

The fail detection module 212 determines whether the AR application 202 fails to properly operate, or crashes. The fail detection module 212 for example includes a monitoring application that communicates with the AR application 202 and detects errors or receive errors messages from the AR application 202. Once the fail detection module 212 detects the error, the fail detection module 212 triggers the safe mode module 214 to operate under a safe mode.

The safe mode module 214 enables the AR device 104 to still operate but with limited functionalities when the AR application 202 crashes. For example, the safe mode module 214 kills (e.g., quits) pending tasks or operations performed by the AR application 202 and executes the safe mode module 214. The safe mode module 214 generates or maintains an augmented reality user interface that is consistent with the AR application 202. For example, the AR application 202 renders a three-dimensional virtual object floating on a desk. An animation or operation of the three-dimensional virtual object results in an error that freezes the AR application 202. The fail detection module 212 detects the error, kills the AR application 202, and starts the safe mode module 214. The safe mode module 214 generates and displays a three-dimensional virtual model of a debug console floating over the desk to retain the consistency of the user 102 being immersed in the augmented reality environment.

In another example, the safe mode module 214 retains limited functionalities of the AR application 202 to allow the user to still perform basic functions such as selecting commands from a virtual menu. For example, the safe mode module 214 still enables gesture control or eye gaze detection to enable the user to navigate through virtual menus. On the other hand, the safe mode module 214 may disable a sound function of the AR application 202 in a safe mode because sound may not be used for debugging the AR application 202.

In one example embodiment, the safe mode module 214 includes a basic AR application that includes limited functionalities of the AR application 202. In another embodiment, the safe mode module 214 may be rooted in the OS 216 and activated in response to detecting a failure (e.g., crash) of the AR application 202.

Any one or more of the modules described herein may be implemented using hardware (e.g., a processor 210 of the AR device 104) or a combination of hardware and software. For example, any module described herein may configure a processor 210 to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

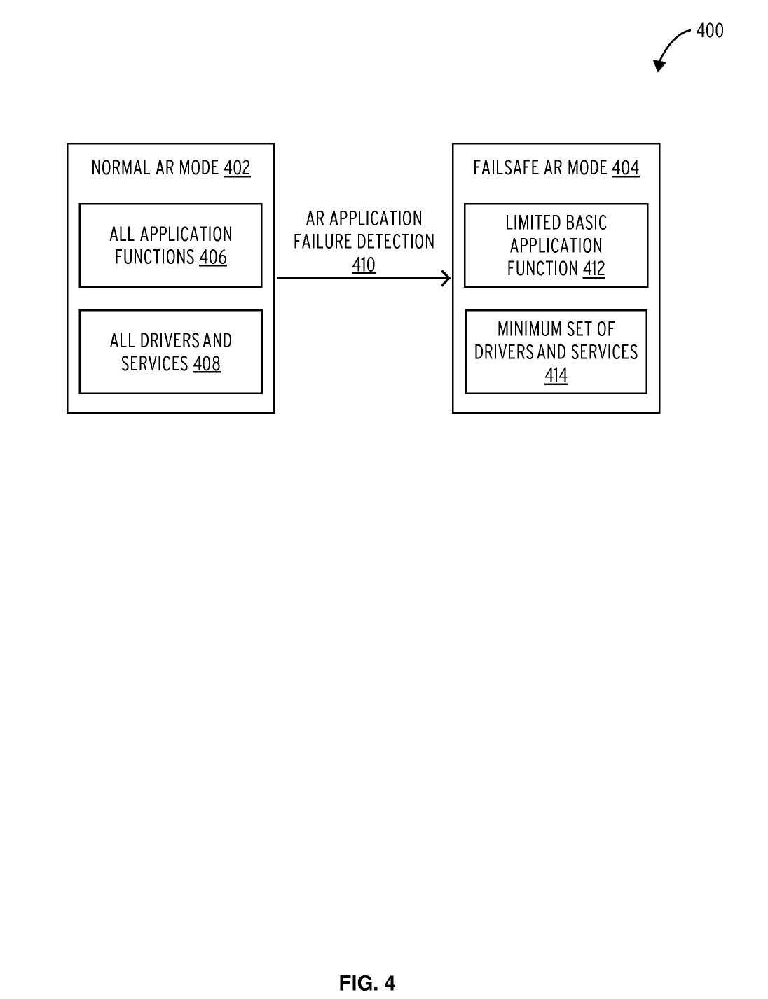

FIG. 4 is a block diagram illustrating an example embodiment of a transition from a normal AR mode to a failsafe AR mode. In a normal AR mode 402 of the AR device 104, all application functions 406 and all drivers and services 408 from the AR application 202 are available and operational in the AR device 104. When the fail detection module 212 detects that the AR application is crashing or has crashed, the fail detection module 212 directs the AR device 104 to switch from the normal AR mode 402 to the failsafe AR mode 404. For example, the AR device kills the AR application 202 and starts the safe mode module 214. The safe mode module 214 operates the failsafe AR mode 404 in the AR device 104.

In one example embodiment, the failsafe AR mode 404 includes limited basic application functions 412 and a minimum set of drivers and services 414. The limited basic application functions 412 includes identifying a core set of physical objects. For example, the AR device 104 can still identify and recognize exit signs in a building, danger signs, or other predefined signs. The AR device 104 can still render basic virtual content based on the core set of physical objects. For example, the AR device 104 can still generate and render emergency valve shut off procedures based on detecting a red flashing light on a machine. In another example, the camera driver of the AR device 104 is still operational while the audio driver and network driver of the AR device 104 is disabled.

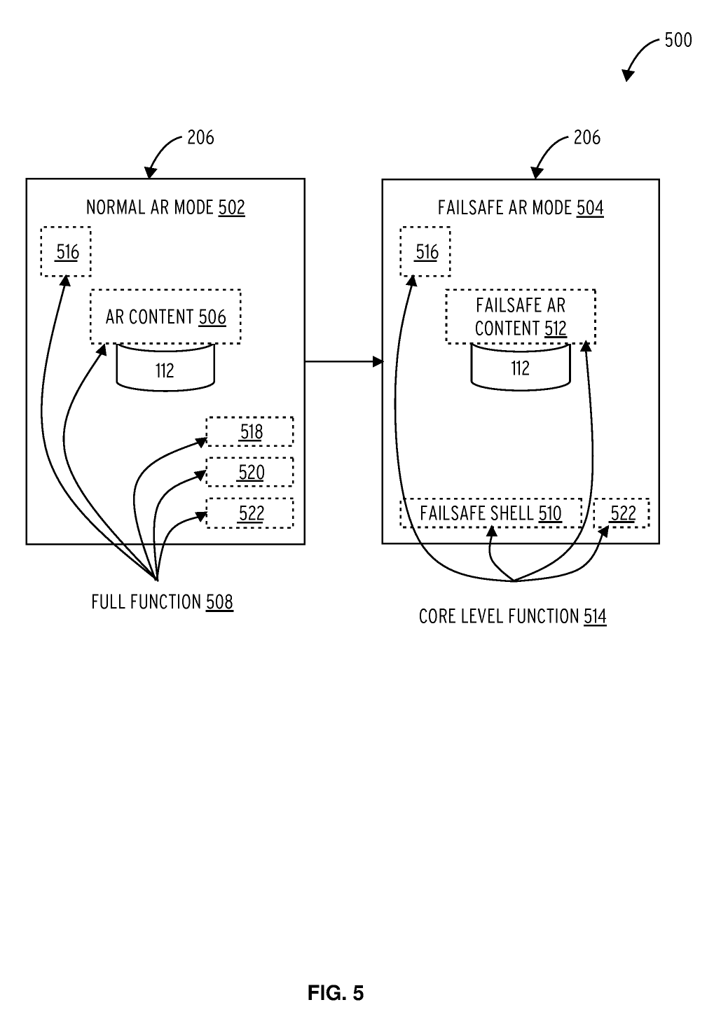

FIG. 5 is a block diagram illustrating an example embodiment of a transition from the normal AR mode 502 to the failsafe AR mode 504. In particular, FIG. 5 illustrates example of displays 206 of the AR device 104 that operates under the normal AR mode 502 and under a failsafe AR mode 504. Under the normal AR mode 502, all functions 508 of the AR application 202 are available and operational. For example, the AR application 202 detects and identifies the physical object 112. The AR application 202 generates and renders an AR content 506 (e.g., a three-dimensional model of a virtual object) that is associated or corresponds to the identified physical object 112. The AR application 202 generates and displays user interface virtual objects 516, 518, 520, and 522.

Under the failsafe AR mode 504, only core level functions 514 of the AR application 202 are available and operational. Core level functions 514 may be predefined by a developer of the AR application 202. For example, the AR application 202 can still detect and identify the physical object 112. The AR application 202 generates and renders not the original AR content 506 associated with the identified physical object 112, but an AR content associated with the failsafe AR mode 504: failsafe AR content 512. In another example embodiment, the failsafe AR content 512 is associated with the failsafe mode and the physical object 112. In other words, different failsafe AR content may be displayed on another physical object different from the physical object 112.

The AR application 202 in the failsafe AR mode 504 also generates and displays a limited number of user interface virtual objects: 516 and 522 that are deemed to be part of a core functionality. In another example, the AR application 202 displays a failsafe shell 510 to enable the user of the AR device 104 to debug the AR application 202.

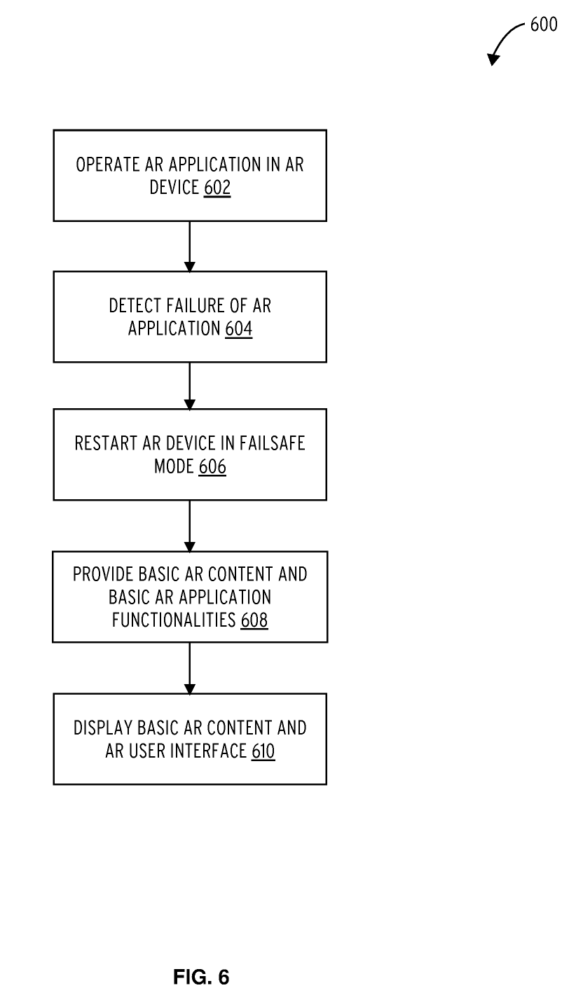

FIG. 6 is a flowchart illustrating a method 600 for operating a failsafe mode of an AR device, according to an example embodiment. At operation 602, the AR device 104 operates or executes the AR application 202. In one example embodiment, operation 602 may be implemented with the AR application 202.

At operation 604, the AR device 104 detects a failure of the AR application 202. In one example embodiment, operation 604 may be implemented with the fail detection module 212.

At operation 606, the AR device 104 restarts the AR device to a failsafe mode. In one example embodiment, operation 606 may be implemented with the safe mode module 214.

At operation 608, the AR device 104 provides basic AR content and basic AR application functionalities under the failsafe mode. In one example embodiment, operation 608 may be implemented with the safe mode module 214.

At operation 610, the AR device displays basic AR content and AR user interface. In one example embodiment, operation 610 may be implemented with the safe mode module 214.

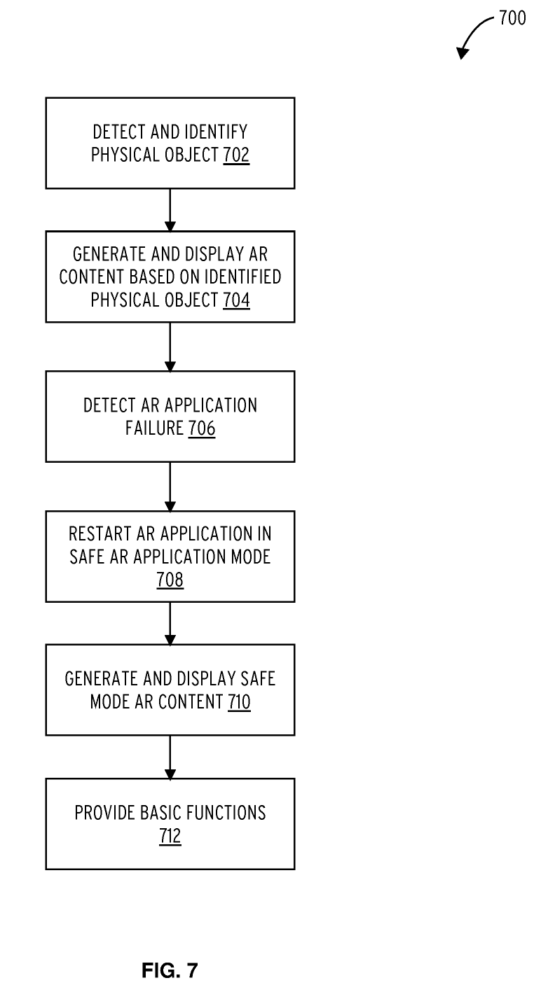

FIG. 7 is a flowchart illustrating a method 700 for operating a failsafe mode of an AR device, according to an example embodiment. At operation 702, the AR device 104 detects and identifies the physical object 112. In one example embodiment, operation 702 may be implemented with the AR application 202.

At operation 704, the AR device 104 generates and displays AR content based on the identified physical object 112. In one example embodiment, operation 704 may be implemented with the AR application 202.

At operation 706, the AR device 104 detects a failure of the AR application 202. In one example embodiment, operation 706 may be implemented with the fail detection module 212.

At operation 708, the AR device 104 restarts the AR device 104 to a failsafe application mode. In one example embodiment, operation 708 may be implemented with the safe mode module 214.

At operation 710, the AR device 104 generates and displays safe mode AR content under the failsafe mode. In one example embodiment, operation 710 may be implemented with the safe mode module 214.

At operation 712, the AR device 104 provides basic AR functions under the failsafe mode. In one example embodiment, operation 712 may be implemented with the safe mode module 214.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor 210 or a group of processors 210) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 210 or other programmable processor 210) that is temporarily configured by software to perform certain operations. It will be appreciated that the decision to implement a hardware module mechanically, in dedicated and permanently configured circuitry, or in temporarily configured circuitry (e.g., configured by software), may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 210 configured using software, the general-purpose processor 210 may be configured as respective different hardware modules at different times. Software may accordingly configure a processor 210, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors 210 that are temporarily configured (e.g., by software) or permanently configured to perform the relevant operations. Whether temporarily or permanently configured, such processors 210 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 210 or processor-implemented modules. The performance of certain of the operations may be distributed among the one or more processors 210, not only residing within a single machine, but deployed across a number of machines. In some example embodiments, the processor or processors 210 may be located in a single location (e.g., within a home environment, an office environment, or as a server farm), while in other embodiments the processors 210 may be distributed across a number of locations.

The one or more processors 210 may also operate to support performance of the relevant operations in a “cloud computing” environment or as a “software as a service” (SaaS). For example, at least some of the operations may be performed by a group of computers (as examples of machines including processors 210), these operations being accessible via a network 106 and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 210, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network 106.

In example embodiments, operations may be performed by one or more programmable processors 210 executing a computer program to perform functions by operating on input data and generating output. Method operations can also be performed by, and an apparatus of example embodiments may be implemented as, special purpose logic circuitry (e.g., a FPGA or an ASIC).

A computing system can include clients and servers 108. A client and server 108 are generally remote from each other and typically interact through a communication network 106. The relationship of client and server 108 arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 210), or a combination of permanently and temporarily configured hardware may be a design choice. Below are set out hardware (e.g., machine) and software architectures that may be deployed, in various example embodiments.

### Example Machine Architecture

FIG. 8 is a block diagram of a machine in the example form of a computer system 800 within which instructions 806 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server 108, or as a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions 806 (sequential or otherwise) that specify actions to be taken by that machine. Further, while only a single machine is illustrated, the term “machine” shall also be taken to include any collection of machines that individually or jointly execute a set (or multiple sets) of instructions 806 to perform any one or more of the methodologies discussed herein.

The example computer system 800 includes a processor 804 (e.g., a central processing unit (CPU), a graphics processing unit (GPU), or both), a main memory 810 and a static memory 822, which communicate with each other via a bus 812. The computer system 800 may further include a video display unit 808 (e.g., a liquid crystal display (LCD) or a cathode ray tube (CRT)). The computer system 800 also includes an alphanumeric input device 814 (e.g., a keyboard), a user interface (UI) navigation (or cursor control) device 816 (e.g., a mouse), a disk drive unit 802, a signal generation device 820 (e.g., a speaker) and a network interface device 824.

### Machine-Readable Medium

The drive unit 802 includes a machine-readable medium 818 on which is stored one or more sets of data structures and instructions 806 (e.g., software) embodying or utilized by any one or more of the methodologies or functions described herein. The instructions 806 may also reside, completely or at least partially, within the main memory 810 and/or within the processor 804 during execution thereof by the computer system 800, the main memory 810 and the processor 804 also constituting computer-readable media 818. The instructions 806 may also reside, completely or at least partially, within the static memory 822.

While the computer-readable medium 818 is shown, in an example embodiment, to be a single medium, the term “machine-readable medium” and “computer-readable medium” may include a single medium or multiple media (e.g., a centralized or distributed database, and/or associated caches and servers 108) that store the one or more instructions 806 or data structures. The term “machine-readable medium” shall also be taken to include any tangible medium that is capable of storing, encoding, or carrying instructions 806 for execution by the machine and that cause the machine to perform any one or more of the methodologies of the present embodiments, or that is capable of storing, encoding or carrying data structures utilized by or associated with such instructions 806. The term “machine-readable medium” shall accordingly be taken to include, but not be limited to, solid-state memories and optical and magnetic media. Specific examples of computer-readable media 818 include non-volatile memory, including by way of example semiconductor memory devices (e.g., erasable programmable read-only memory (EPROM), electrically erasable programmable read-only memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 806 may further be transmitted or received over a communications network 826 using a transmission medium. The instructions 806 may be transmitted using the network interface device 824 and any one of a number of well-known transfer protocols (e.g., HTTP). Examples of communication networks 826 include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions 806 for execution by the machine, and includes digital or analog communications signals or other intangible media to facilitate communication of such software.

Although an embodiment has been described with reference to specific example embodiments, it will be evident that various modifications and changes may be made to these embodiments without departing from the scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those skilled in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The following enumerated embodiments describe various example embodiments of methods, machine-readable media, and systems (e.g., machines, devices, or other apparatus) discussed herein.

A first embodiment provides a device (e.g., an AR display device) comprising:
one or more hardware processors; and
a memory storing instructions that, when executed by the one or more hardware processors, configure the device to perform operations comprising:

operating an augmented reality (AR) application in the device;

detecting a failure of the AR application; and

providing a failsafe mode of the AR application in response to detecting the failure of the AR application, the failsafe mode including a limited set of AR content and AR application functionalities relative to the full set of AR content and AR application functionalities when the AR application is operating.

A second embodiment provides a device according to the first embodiment, further comprises:
a sensor;
a display,
wherein operating the AR application further comprises:

detecting and identifying a physical object with the sensor;

generating and rendering a first AR content in the display as an overlay of the physical object, the first AR content including a three-dimensional model of a first virtual object associated with the identified physical object;

adjusting a display of the first AR content based on a relative position between the device and the physical object; and

generating a first virtual user interface in the display, the first virtual user interface providing a first set of functions to control the first AR content.

A third embodiment provides a device according to the second embodiment, wherein the operations further comprises:
replacing the first virtual user interface in the display with a second virtual user interface, the second virtual user interface providing a second set of functions to control the first AR content, the second set of functions including basic functionalities of the AR application, the first set of functions including all functionalities of the AR application.

A fourth embodiment provides a device according to the second embodiment, wherein the operations further comprises:
replacing the first AR content with a second AR content in the display in response to detecting the failure of the AR application; and
replacing the first virtual user interface in the display with the a second virtual user interface, the second virtual user interface providing a second set of functions to control the second AR content, the second set of functions including basic functionalities of the AR application, the first set of functions including all functionalities of the AR application.

A fifth embodiment provides a device according to the second embodiment, wherein the second AR content includes a three-dimensional model of a second virtual object associated with the identified physical object.

A sixth embodiment provides a device according to the fifth embodiment, wherein the second virtual object is a subset of the first virtual object.

A seventh embodiment provides a device according to the fifth embodiment, wherein the second AR content includes a three-dimensional user interface configured to debug the AR application.

An eighth embodiment provides a device according to the first embodiment, wherein the operations further comprises:
restarting the device in the failsafe mode of the AR application in response to detecting the failure of the AR application.

A ninth embodiment provides a device according to the first embodiment, wherein the operations further comprises:
switching the device from the AR application to the failsafe mode without restarting the device.

A tenth embodiment provides a device according to the first embodiment, wherein the failsafe mode is configured to provide a failure diagnostic tool and a virtual text-debug console in an augmented reality display setting generated by the device, wherein the failure diagnostic tool and a virtual text-debug console retains a three-dimensional user interface in the augmented reality display setting.

1. A device comprising:
one or more hardware processors; and
a memory storing instructions that, when executed by the one or more hardware processors, configure the device to perform operations comprising:
executing an augmented reality (AR) application in the device;
detecting that an operation of the AR application is crashing; and
entering a failsafe mode of the AR application in response to detecting that the operation of the AR application is crashing, the failsafe mode enabling the AR application to operate with a basic set of AR content and AR application functionalities relative to a full set of AR content and AR application functionalities when the AR application is being executed.

2. The device of claim 1, further comprising:
a sensor;
a display,
wherein operating the AR application further comprises:
identifying a physical object with the sensor;
rendering first AR content in the display obscuring a portion of the physical object, the first AR content including a three-dimensional model of a first virtual object associated by a database with the identified physical object;
adjusting a rendering of the first AR content based on a relative position between the device and the physical object; and
generating a first virtual user interface in the display, the first virtual user interface providing a first set of functions to control the first AR content.

3. The device of claim 2, wherein the operations further comprise:
replacing the first virtual user interface in the display with a second virtual user interface, the second virtual user interface providing a second set of functions to control the first AR content, the second set of functions including a minimal number of functionalities of the AR application, the first set of functions including all functionalities of the AR application.

4. The device of claim 2, wherein the operations further comprise:
replacing the first AR content with second AR content in the display in response to detecting that the operation of the AR application is crashing; and
replacing the first virtual user interface in the display with the a second virtual user interface, the second virtual user interface providing a second set of functions to control the second AR content, the second set of functions including a minimum number of functionalities of the AR application, the first set of functions including all functionalities of the AR application.

5. The device of claim 4, wherein the second AR content includes a three-dimensional model of a second virtual object associated by the database with the identified physical object.

6. The device of claim 5, wherein the second virtual object is a subset of the first virtual object.

7. The device of claim 5, wherein the second AR content includes a three-dimensional user interface configured to include controls operable to debug the AR application.

8. The device of claim 1, wherein the operations further comprises:
restarting the device in the failsafe mode of the AR application in response to detecting that the operation of the AR application is crashing.

9. The device of claim 1, wherein the operations further comprises:
switching the device from the AR application to the failsafe mode without restarting the device.

10. The device of claim 1, wherein the failsafe mode includes a failure diagnostic tool and a virtual text-debug console provided in an AR display setting generated by the device, wherein the failure diagnostic tool and the virtual text-debug console retains a three-dimensional user interface in the augmented reality display setting.

11. A method comprising:
executing, using one or more processors of a device, an augmented reality (AR) application in the device;
detecting that an operation of the AR application is crashing; and
entering a failsafe mode of the AR application in response to detecting that the operation of the AR application is crashing, the failsafe mode enabling the AR application to operation with a basic set of AR content and AR application functionalities relative to a full set of AR content and AR application functionalities when the AR application is being executed.

12. The method of claim 11, further comprising:
identifying a physical object with a sensor of the device;
rendering a first AR content in a display of the device obscuring a portion of the physical object, the first AR content including a three-dimensional model of a first virtual object associated by a database with the identified physical object;
adjusting a rendering of the first AR content based on a relative position between the device and the physical object; and
generating a first virtual user interface in the display, the first virtual user interface providing a first set of functions to control the first AR content.

13. The method of claim 12, further comprising:
replacing the first virtual user interface in the display with a second virtual user interface, the second virtual user interface providing a second set of functions to control the first AR content, the second set of functions including a minimal number of functionalities of the AR application, the first set of functions including all functionalities of the AR application.

14. The method of claim 12, further comprising:
replacing the first AR content with second AR content in the display in response to detecting that the operation of the AR application is crashing; and
replacing the first virtual user interface in the display with the a second virtual user interface, the second virtual user interface providing a second set of functions to control the second AR content, the second set of functions including a minimum number of functionalities of the AR application, the first set of functions including all functionalities of the AR application.

15. The method of claim 4, wherein the second AR content includes a three-dimensional model of a second virtual object associated by the database with the identified physical object.

16. The method of claim 15, wherein the second virtual object is a subset of the first virtual object.

17. The method of claim 15, wherein the second AR content includes a three-dimensional user interface configured to include controls operable to debug the AR application.

18. The method of claim 11, further comprising:
restarting the device in the failsafe mode of the AR application in response to detecting that the operation of the AR application is crashing.

19. The method of claim 11, further comprising:
switching the device from the AR application to the failsafe mode without restarting the device.

20. A non-transitory machine-readable medium comprising instructions that, when executed by one or more processors of a machine, cause the machine to perform operations comprising:
executing an augmented reality (AR) application in the device;
detecting that an operation of the AR application is crashing; and
entering a failsafe mode of the AR application in response to detecting that the operation of the AR application is crashing, the failsafe mode enabling the AR application to operation with a basic set of AR content and AR application functionalities relative to a full set of AR content and AR application functionalities when the AR application is being executed.
